(19) United States
(12) Patent Application Publication
(10) Pub. No.: US 2017/0039578 A1
(43) Pub. Date: Feb. 9, 2017

(54) Ranking of Search Results Based on Customer Intent

(71) Applicant: Staples, Inc., Framingham, MA (US)

(72) Inventors: Taraknath Woddi, Renton, WA (US); Jonathan Edwards, Bellevue, WA (US); Stephen Woundy, Farmingham, MA (US); Venkatesan Ramanathan, Bellevue, WA (US)

(21) Appl. No.: 14/981,041

(22) Filed: Dec. 28, 2015

Related U.S. Application Data
(60) Provisional application No. 62/200,632, filed on Aug. 3, 2015.

(51) Int. Cl. G06Q 30/02; G06Q 30/06; G06F 17/30

(52) U.S. Cl. CPC G06Q 30/0201; G06F 17/3053; G06F 17/30867; G06Q 30/0625

(57) ABSTRACT

The disclosure describes technology for ranking search results based on customer intent. A set of matching product entries matching the one or more search keywords is determined from among product entries stored in a product database reflecting products purchasable via one or more online marketplaces. For each product entry, scores are computed using different combinations of coefficients and an amount of revenue-per-visit, a number of orders, and a ratio of page visits to product views associated with the product entry. The set of matching product entries are ranked based on a rank associated with each matching product entry in the set of matching product entries. The rank is computed based on a comparison between a plurality of scores associated with the matching product entry.

### CROSS REFERENCE TO RELATED APPLICATIONS

The present application claims the benefit under 35 U.S.C. §119(e) of U.S. Provisional Patent Application No. 62/200,632, filed Aug. 3, 2015, entitled “RANKING OF SEARCH RESULTS BASED ON CUSTOMER INTENT,” the entire contents of which are incorporated herein by reference.

### BACKGROUND

The present specification generally relates to the field of optimizing the order of search results.

The use of the internet to promote and sell products has proliferated in recent years to the point where it has become a significant portion of retail sales. When responding to a product search, retailers generally use a relevancy algorithm that matches the text terminology to the product list and identifies the relevant list of products to be presented to the customer. The product list is generally sorted by default using an ordering algorithm applied to all customers (e.g., best match). Beyond the search keywords used, this ordering algorithm often does not anticipate customer intent or product compatibility measures, and as such does not satisfy stringent customer and market requirements. As a consequence, customers are increasingly abandoning their searches and retailers are experiencing lower conversion rates.

Thus, there is a need for a search engine that considers customer intent and product compatibility measures when ranking and ordering search results.

### SUMMARY

According to one innovative aspect of the subject matter described in this disclosure, a system for ranking search results based on customer intent includes: a processor; a memory storing instructions that, when executed by the processor, causes the system to: receive a search query including one or more search keywords; responsive to receiving the search query, determining from among product entries stored in the product database reflecting products purchasable via one or more online marketplaces, a set of matching product entries matching the one or more keywords; responsive to determining the set of matching product entries matching the one or more keywords, rank the set of matching product entries based on a rank associated with each matching product entry in the set, the rank computed based on a comparison between a plurality of scores associated with the matching product entry, each of the scores being computed using a different combination of coefficients and an amount of revenue-per-visit (RPV), a number of orders, and a ratio of page visits to product views (Visits/Product Views) associated with the matching product entry; and transmit the ranked set of matching product entries for presentation.

In general, another innovative aspect of the subject matter described in this disclosure may be embodied in methods that include: receiving a search query including one or more search keywords; responsive to receiving the search query, determining from among product entries stored in the product database reflecting products purchasable via one or more online marketplaces, a set of matching product entries matching the one or more keywords; responsive to determining the set of matching product entries matching the one or more keywords, ranking the set of matching product entries based on a rank associated with each matching product entry in the set, the rank computed based on a comparison between a plurality of scores associated with the matching product entry, each of the scores being computed using a different combination of coefficients and an amount of revenue-per-visit (RPV), a number of orders, and a ratio of page visits to product views (Visits/Product Views) associated with the matching product entry; and transmitting the ranked set of matching product entries for presentation.

Other aspects include corresponding methods, systems, apparatus, and computer program products for these and other innovative aspects.

These and other implementations may each optionally include one or more of the following features. For instances, the operations further include: computing the scores for each product entry using different combinations of coefficients and the RPV, the Orders, and the Visits/Product Views associated with the product entry; and computing the rank of each product entry based on the comparison between the plurality of scores associated with the product entry. For instance, the features include: computing the scores for each product entry further includes, for at least one score, comparing a ratio of Orders and a number of cart additions (Cart Additions) to a predetermined threshold, and, if the ratio of Orders/Cart Additions satisfies the predetermined threshold, calculating a score value for the at least one score based on the RPV, the Orders, and the Visits/Product Views associated with the product entry; the predetermined threshold is one or more standard deviations of a scaled value of the Orders/Cart Additions or a scaled value of the Visits/Product Views; computing the scores includes calculating a score value for two or more different cases using the equation:

$$\{ ( \frac{1}{1 + {e}^{- RPV}} ) + ( C 1 * Log ( Orders ) ) + ( C 2 * Log ( \frac{Visits}{Product Views} ) ) \} ,$$

wherein the different cases are based on unique combinations of C1 and C2; and one or more of the RPV, the Orders, and the Visits/Product Views associated with each product entry are scaled relative to a maximum RPV, maximum Orders, and Maximum Visits/Product Views available in the set of product entries.

The present disclosure may be particularly advantageous in a number of respects. The system may provide more pertinent search results to a user, thereby allowing a user to more quickly find products that the user is interested in purchasing. Additionally, the system may increase sales revenue, and may allow a retailer to lower product pricing and/or increase overall profitability.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example computing system for ranking search results based on customer intent.

FIG. 2 is a flowchart of an example method for providing a set of search results ranked using segregated analysis.

FIG. 3 is a block diagram of an example system 300 for ranking search results based on customer intent.

FIG. 4 is a flowchart of an example method for determining product rankings.

FIG. 5 is a flowchart of an example method for performing a simplified segregated analysis.

FIG. 6 is a flowchart of an example method for a performing a multi-tier segregated analysis to compute product scores.

### DETAILED DESCRIPTION

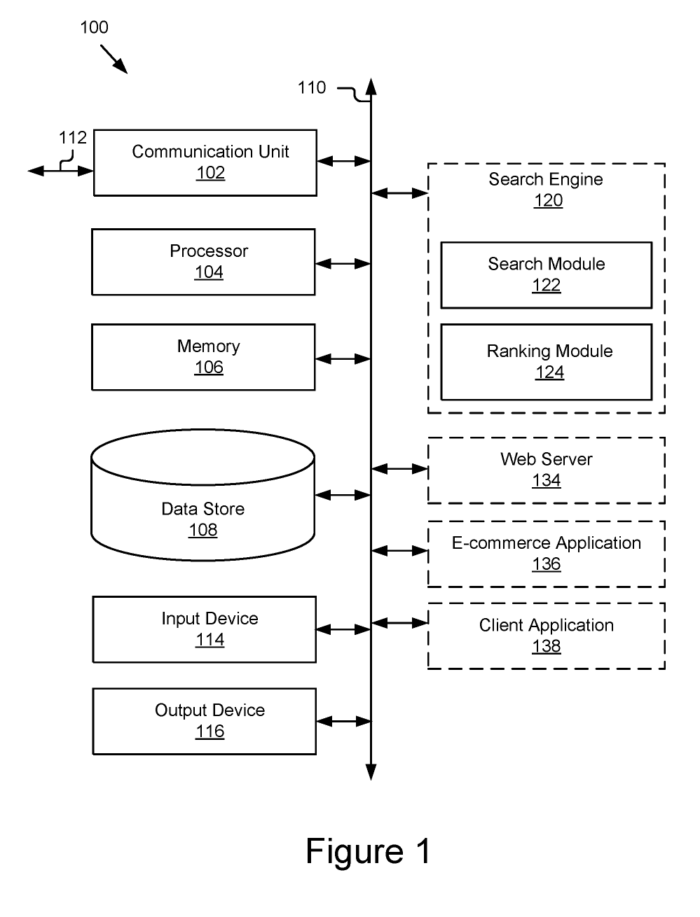

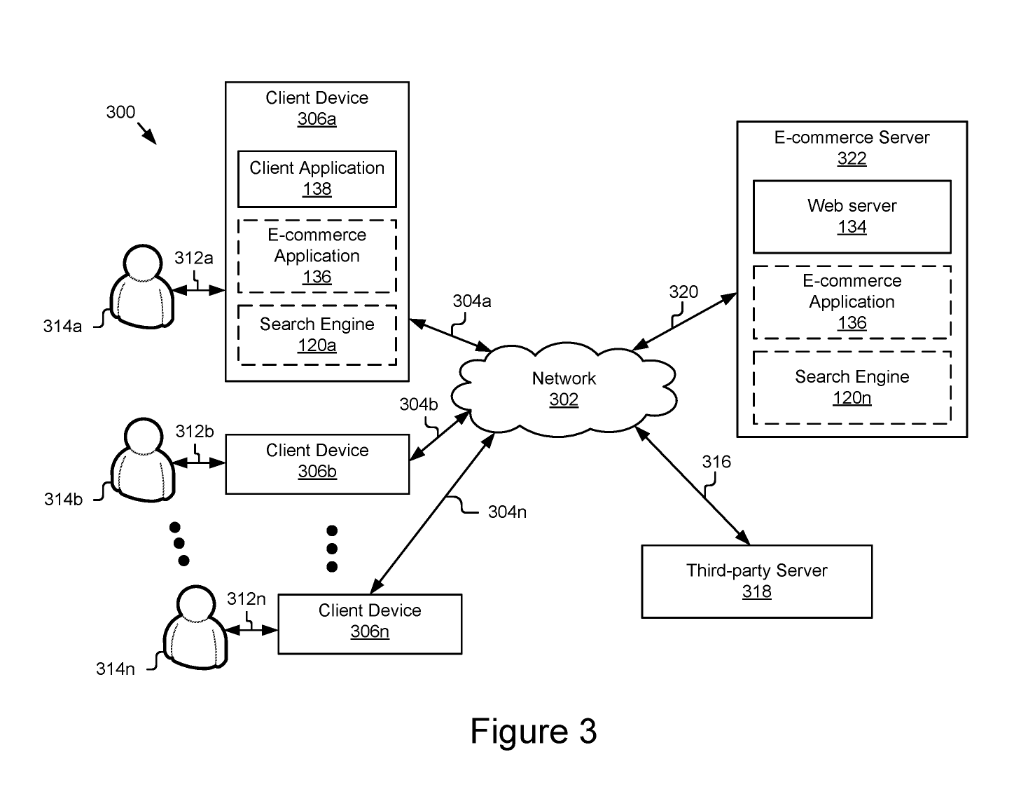

FIG. 1 is a block diagram of an example computing system 100, which may represent the computer architecture of a client device 306, a third-party server 318, and/or an e-commerce server 322, as depicted in FIG. 3, depending on the implementation.

As depicted in FIG. 1, the computing system 100 may include a search engine 120, a web server 134, an e-commerce application 136, and/or a client application 138, depending on the configuration. For instance, a client device 306 may include one or more of the client application 138, the e-commerce application 136, the search engine 120, and/or components thereof; and the e-commerce server 322 may include the web server 120, the e-commerce application 136, the search engine 120, and/or components thereof, although other configurations are also possible and contemplated.

The search engine 120 includes computer logic that, when executed, programs the processor 104 to determine and order search results using novel methods that consider customer intent and product compatibility measures, and thus are the function of certain dependent variables, as discussed further herein. The search engine 120 is coupled to the data store 108 to store, retrieve, and/or manipulate data stored therein and may be coupled to the e-commerce application 136, the web server 134, the client application 138, and/or other components of the system 100 to exchange information therewith.

In the depicted implementation, the search engine 120 includes a search module 122 and a ranking module 124. The search module 122 and the ranking module 124 may be coupled for communication with one another, the web server 134, the e-commerce application 136, and/or the data store 108 to call functions and/or store, update, and/or retrieve data.

In this document, the different computer-executable elements of the system 100, such as the search engine 120, the search component 122, the ranking component, the web server 134, the e-commerce application 136, and the client application 138 may be referred to as the actor (in the third person) for convenience and so as not to obscure the acts, operations, and functionalities (also referred to simply as operations) carried out by them. However, it should be understood that these elements comprise software (set(s) of computer instructions) that, when executed by the processor 104, program the processor 104 to perform the specific operations described herein. Further, it should be understood that these elements (set(s) of computer instructions) or portions thereof could additionally and/or alternatively be implemented in hardware circuitry included in the processor 104, such a field-programmable gate array (FPGA), an application-specific integrated circuit (ASIC), or other suitable circuitry without departing from the scope of this disclosure.

The search module 122 includes computer logic that, when executed, programs the processor 104 to retrieve search results based on a search request. The search module 122 queries a database of product entries, which is included in the data store 108, for entries that match the search request. In some implementations, the search module 122 uses one or more keywords, which may include words or phrases, and compares the keyword(s) to metadata associated with the product entries to determine relevant matches. In performing the comparison, the search module 122 utilizes an existing relevancy algorithm that determines the most relevant products to include in the result set (also called product list).

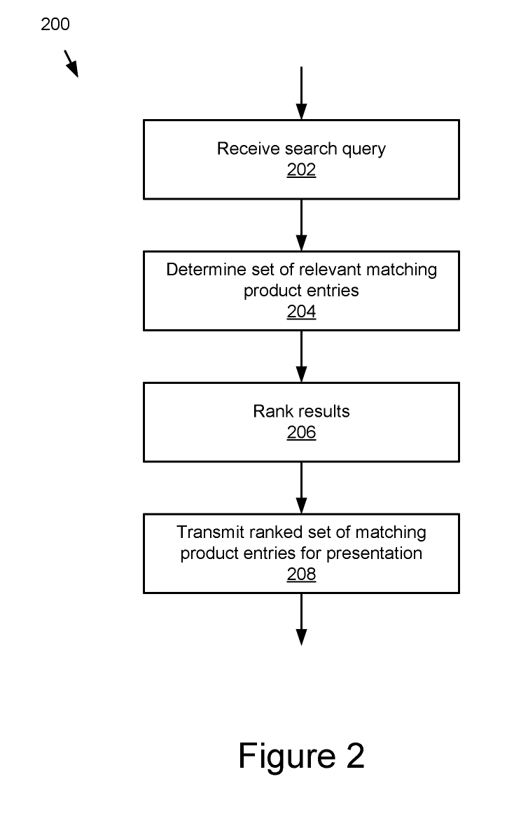

FIG. 2 is a flowchart of an example method 200 for providing a set of search results ranked using a segregated ranking algorithm, and illustrates in part further operations the search module 122 programs the processor 104 to perform. For instance, in block 202, the search module 122 receives a search query including one or more search keywords. In block 204, responsive to receiving the search query, the search module 122 determines, from among product entries stored in the product database reflecting products purchasable via one or more online marketplaces, a set of matching product entries matching the one or more keywords.

Returning to FIG. 1, the ranking module 124 includes computer logic that, when executed, programs the processor 104 to rank the result set determined by the search module 122. In some implementations, the search module 122 may call the ranking module 124 as a function and request the ranking module 124 rank the results determined by it. In these implementations, the search module 122 may pass the result set as a variable to the ranking module 124, and the ranking module may rank the result set and return the ranked result set to the search module 122, which may then format and transmit the result set to the entity from which the search request was received, such as a client computing device. In further embodiments, the search module 122 may store the result set in the data store 108 and the ranking module 124 may retrieve the result set from there. In other embodiments, a controller program included in the search engine 108 may signal the search module 122 and ranking module 124 to perform their respective actions. Other suitable variations are also possible, provided that search results are determined and then ranked in the manner described herein.

FIG. 2 further illustrates example operations that the ranking module 124 programs the processor 104 to perform. For example, in block 206 the ranking module ranks the set of matching product entries based on a rank associated with each matching product entry in the set. The ranking module 124 can compute the rank based on a comparison between a plurality of scores associated with the matching product entry. The ranking module 124 can compute each of the scores using various web analytics data. For example, the ranking module 124 can use a different combination of coefficients and an amount of revenue-per-visit (RPV), a number of orders (orders), and a ratio of page visits to product views (visits/product views) associated with the matching product entry. In some implementations, the ranking module ranks the search results responsive to determining the set of matching product entries matching the one or more keywords.

Once the ranking has been performed, the search module 122, the ranking module 124, or another component may provide the ranked result set to the web server 134, and the web server 134 may transmit the ranked set of matching product entries for presentation (e.g., generate and send a response including the ranked set of search results to a client device 306 that submitted the search request). In some instances, the search results may be provided as a web page, a formatted dataset or object (e.g., XML, JSON, etc.), or any other suitable file, object, data format, etc. As the customer views the ranked result set, the products are sorted per measures important to the customer and merchant, which leads to higher engagement levels, and thus increased click-through and conversion rates.

In a typical implementation, the scores, and thus, the rankings generated based on the scores, are a function of the following dependent variables and/or derivatives thereof: RPV (revenue per visit), orders, cart additions, product views, visits, and ASP (average selling price) (actual and prospective), although it should be understood that further implementations that are contemplated by this document could use additional or alternative variables, provided they directly or implicitly reflect customer action to some extent. The following Table 1 provides a further example of dependent variables associated with products in a sample result set.

| | Product | | | | Prod. | | |
|---|---|---|---|---|---|---|---|
| Index | ID | RPV | Orders | CartAdds | Views | Visits | ASP |
| 1 | 1305396 | 302 | 3 | 7 | 21 | 103 | 163.72 |
| 2 | 1493178 | 119 | 5 | 5 | 11 | 79 | 111.09 |
| 3 | 764796 | 456 | 12 | 23 | 56 | 214 | 84.07 |
| 4 | 1326714 | 0 | 0 | 4 | 21 | 178 | 67.62 |
| 5 | 1056414 | 214 | 4 | 6 | 10 | 112 | 56.56 |
| 6 | 989971 | 481 | 1 | 1 | 1 | 43 | 48.6 |
| 7 | 923528 | 521 | 2 | 5 | 17 | 39 | 42.61 |
| 8 | 857086 | 0 | 0 | 0 | 0 | 21 | 37.93 |
| 9 | 790643 | 314 | 16 | 19 | 41 | 256 | 34.18 |
| 10 | 724200 | 644 | 1 | 1 | 3 | 25 | 31.11 |
| 11 | 657757 | 442 | 9 | 10 | 31 | 190 | 28.54 |
| 12 | 591314 | 178 | 8 | 8 | 22 | 228 | 26.36 |
| 13 | 524872 | 0 | 0 | 0 | 10 | 113 | 24.49 |
| 14 | 458429 | 501 | 3 | 4 | 9 | 73 | 22.87 |
| 15 | 391986 | 304 | 10 | 10 | 18 | 39 | 21.45 |
| 16 | 325543 | 0 | 0 | 2 | 12 | 43 | 20.2 |
| 17 | 259100 | 103 | 2 | 2 | 5 | 7 | 19.08 |
| 18 | 192658 | 609 | 11 | 18 | 46 | 310 | 18.08 |
| 19 | 126215 | 101 | 7 | 9 | 33 | 232 | 17.19 |
| 20 | 59772 | 502 | 1 | 2 | 19 | 116 | 16.37 |

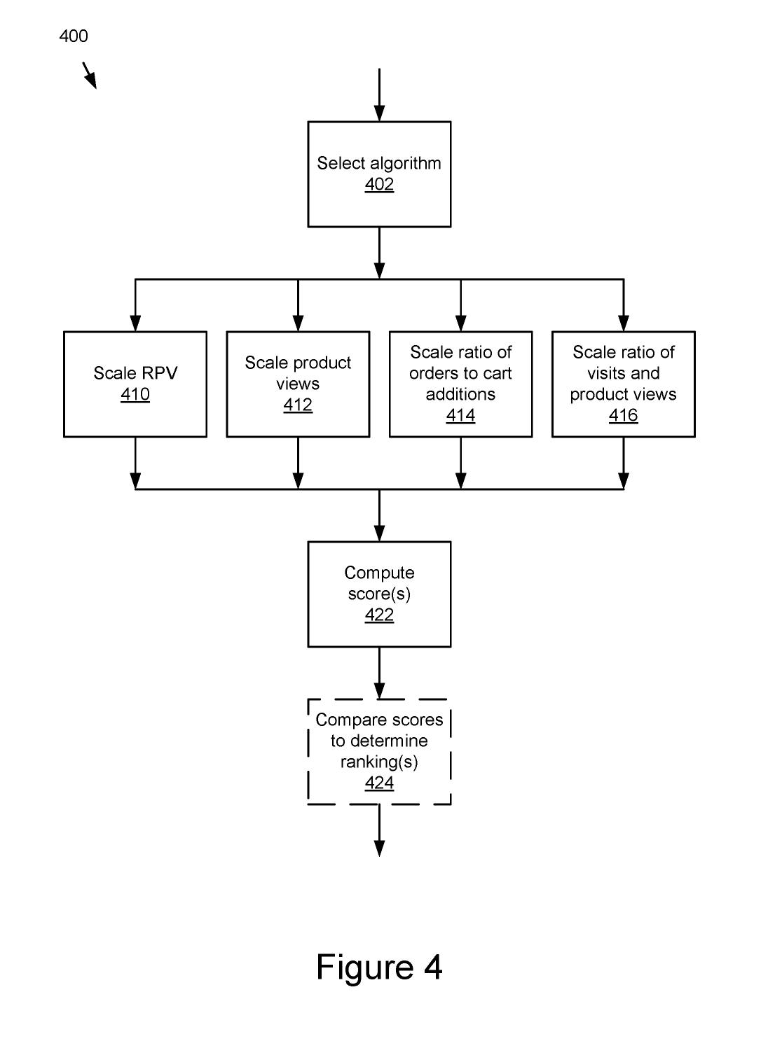

In some implementations, the ranking module 124 uses, as input variables, scaled values for the dependent variables or ratios thereof For instance, the example method 400 depicted in FIG. 4 and executed by the ranking module 124, computes score(s) for product entr(ies) using one or more such scaled input variables. In particular, in block 402, the method 400 determines the ranking algorithm(s) to be used, and proceeds to compute the effective input variables for the algorithms (which are used for ranking pre-selected products), such as RPV, ratio of orders to cart additions, and ratio of visits to product views.

When computing the input variables, the method 400 can scale them as follows. In block 410, the RPV is scaled by dividing the RPV of the particular product with the maximum RPV of a product in the list/result set. In block 412, the product views are scaled by dividing the product views of the particular product with the maximum product views value of a product in the list. In block 414, the ratio of orders to cart additions is scaled by dividing the ratio of orders to cart additions of the particular product with the maximum ratio value of a product in the list.

In block 416, the ratio of visits and product views is scaled by dividing the ratio of visits and product views of the particular product with the maximum ratio value of a product in the list.

As a further non-limiting example, Table 2 provides an example set of ratio values and scaled values for the sample result set.

| | | | | (Orders/ | | | |
|---|---|---|---|---|---|---|---|
| | | | Orders/ | Cart Adds) | Prod_Views | (Visits/ | (Visits/Prod_Views) |
| Index | Product_ID | RPV Scale | Cart Adds | Scale | Scale | Prod_Views) | Scale |
| 1 | 1305396 | 0.468944099 | 0.428571429 | 0.428571429 | 0.375 | 4.904761905 | 0.11406423 |
| 2 | 1493178 | 0.184782609 | 1 | 1 | 0.196428571 | 7.181818182 | 0.167019027 |
| 3 | 764796 | 0.708074534 | 0.52173913 | 0.52173913 | 1 | 3.821428571 | 0.088870432 |
| 4 | 1326714 | 0 | 0 | 0 | 0.375 | 8.476190476 | 0.197120709 |
| 5 | 1056414 | 0.332298137 | 0.666666667 | 0.666666667 | 0.178571429 | 11.2 | 0.260465116 |
| 6 | 989971 | 0.74689441 | 1 | 1 | 0.017857143 | 43 | 1 |
| 7 | 923528 | 0.809006211 | 0.4 | 0.4 | 0.303571429 | 2.294117647 | 0.053351573 |
| 8 | 857086 | 0 | 1 | 1 | 0 | 1 | 0.023255814 |
| 9 | 790643 | 0.48757764 | 0.842105263 | 0.842105263 | 0.732142857 | 6.243902439 | 0.145207033 |
| 10 | 724200 | 1 | 1 | 1 | 0.053571429 | 8.333333333 | 0.19379845 |
| 11 | 657757 | 0.686335404 | 0.9 | 0.9 | 0.553571429 | 6.129032258 | 0.142535634 |
| 12 | 591314 | 0.276397516 | 1 | 1 | 0.392857143 | 10.36363636 | 0.241014799 |
| 13 | 524872 | 0 | 1 | 1 | 0.178571429 | 11.3 | 0.262790698 |
| 14 | 458429 | 0.777950311 | 0.75 | 0.75 | 0.160714286 | 8.111111111 | 0.188630491 |
| 15 | 391986 | 0.472049689 | 1 | 1 | 0.321428571 | 2.166666667 | 0.050387597 |
| 16 | 325543 | 0 | 0 | 0 | 0.214285714 | 3.583333333 | 0.083333333 |
| 17 | 259100 | 0.159937888 | 1 | 1 | 0.089285714 | 1.4 | 0.03255814 |
| 18 | 192658 | 0.945652174 | 0.611111111 | 0.611111111 | 0.821428571 | 6.739130435 | 0.156723964 |
| 19 | 126215 | 0.156832298 | 0.777777778 | 0.777777778 | 0.589285714 | 7.03030303 | 0.163495419 |
| 20 | 59772 | 0.779503106 | 0.5 | 0.5 | 0.339285714 | 6.105263158 | 0.141982864 |

The method 400 then proceeds to compute the score(s) in block 422 for the product(s) using the above-noted algorithm(s) and scaled input variables. In some embodiments, the method 400 may compute more than one score for each product and then compare the scores to determine a product rank, as shown in block 424.

In some implementations, the ranking module 124 uses segregated analysis to compute the rank of each product. Using segregated analysis, the ranking module 124 computes two or more scores for each product entry in the list and then computes the rank of each product entry based on the comparison between the scores associated with the product entry. Under the comparison, the ranking module 124 may, in some cases, select the rank from the scores based on one or more selection criteria, as discussed further herein.

In some implementations, during the analysis, the ranking module 124 computes the scores for each product entry using different combinations of coefficients and the RPV, the orders, and the visits/product views associated with the product entry, and then determines the rank based using the scores and selection criteria, as discussed further elsewhere herein.

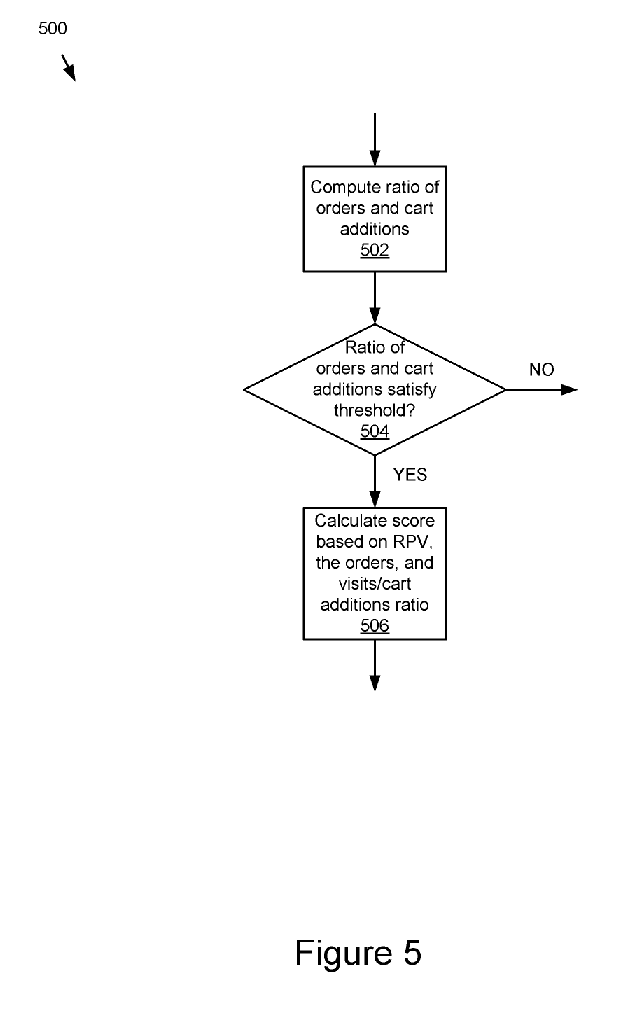

FIG. 5 is a flowchart of an example method 500 for performing a simplified segregated analysis. In block 502, the ranking module 124 computes the ratio of orders and cart additions. For instance, in the computation of at least one of the scores, the ranking module 124 may compare 504 a ratio of orders and a number of cart additions to a predetermined threshold, and, if the ratio of orders/cart additions satisfies the predetermined threshold, calculates 506 a score value for the at least one score based on the RPV, the orders, and the visits/product views associated with the product entry. In this example, the selection criteria, or the predetermined threshold, may be one or more standard deviations of a scaled value of the orders/cart additions or a scaled value of the visits/product views.

In some implementations, the segregated analysis may be multi-tiered to account for the different stages of a user's browsing cycle. For example, different classes of equations may be associated with different stages and ranking module 124 may be configured to utilize a specific equation or class of equations to compute the score(s), or may utilize each equation and then compare the output to determine the most suitable score.

For instance, in the following example, the product list ranking may be attained by two or more (e.g., two, three, etc.) classes of segregated analysis depending on the products identified by relevance, and each of the classes has at least one equation or data simulation step that is used by the ranking module 124 to determine the product score(s).

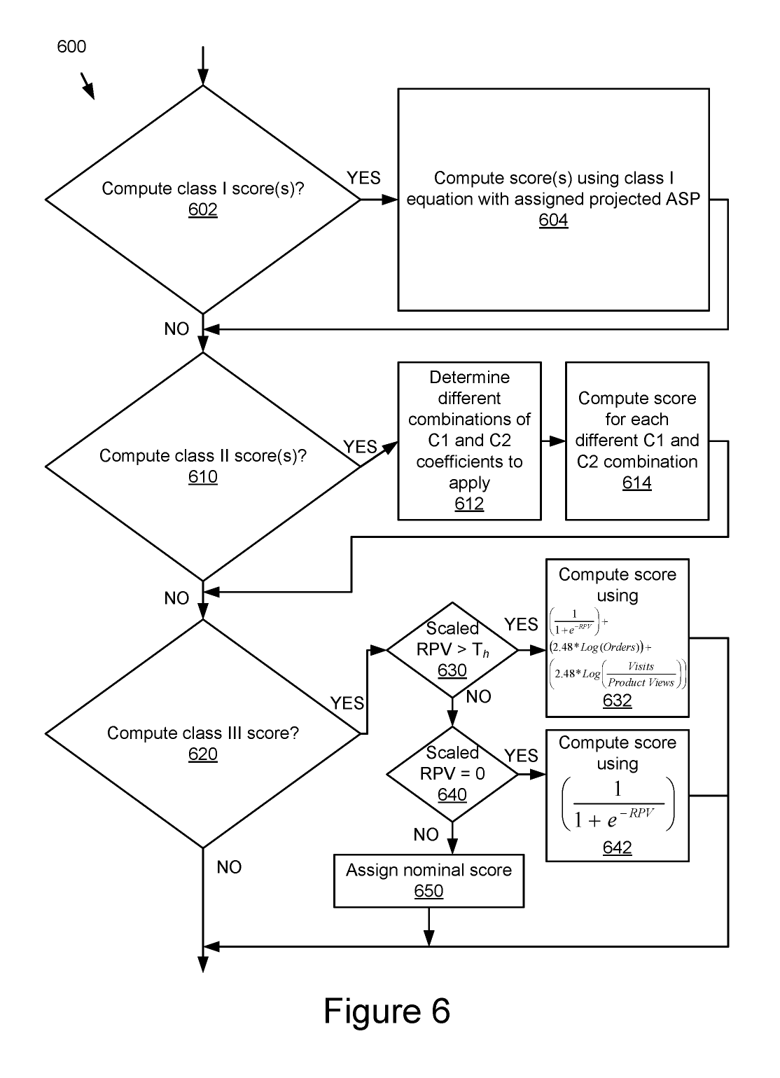

Accordingly, FIG. 6 is a flowchart of an example method 600 for a segregated analysis where multiple equations are employed to compute a product scores. The method 600 proceeds along a series of determinations on whether to compute a class I score 602, a class II score 610 and/or a class III score 620.

A class I score may be implemented to bring into prominence products that a customer has searched for but for which a standing business record does not exist. A class II relevance score can compensate for price fluctuations over a certain period (e.g., period of 24 hours). Margin data can be used over an average time period (e.g., a day) to the ASM (Average Sale Margin) and is important driving factor for tie breaking in the promotion of high margin product. Class III relevancy scoring can bring high revenue products (e.g., more quantity sold/high priced products relative to other product offerings) with a low bounce rate (e.g., customer landing on a page and then exiting without engaging with any other pages) into prominence. A non-limiting example of a low bounce rates is 26 to 40 percent, although it should be understood that a low bounce rate can vary and is situationally dependent.

In block 602, if the method 600 determines to compute a class I score, the method 600 proceeds to compute the score(s) using a class I equation with an assigned projected ASP 604, such

$$\{ ( \frac{1}{1 + {e}^{- GrossRPV}} ) + ( C 1 * Log ( Orders ) ) + ( C 2 * Log ( \frac{Visits}{Product Views} ) ) \} ,$$

Gross RPV precludes discounts and emphasizes the actual sale price. This equation is beneficial when margin and ASP fluctuates within a period of time (e.g., a day), because it can average the margin over that period. Alternatively, the class I equation may be equation 1 (see below) with all coefficients set to 1, which can identify the products that have longevity in existence (e.g., sell well over a time period). Upon computing the score(s), or if the determination in block 602 was negative, the method 600 proceeds to blocks 610 and 620 to respectively determine whether to compute class II and class III scores.

In some embodiments, to compute the class II and class III scores, the ranking module 124 computes the scores for two or more different cases using variations of the equation:

$$\{ ( \frac{1}{1 + {e}^{- RPV}} ) + ( C 1 * Log ( Orders ) ) + ( C 2 * Log ( \frac{Visits}{Product Views} ) ) \} ,$$

in which the different cases are based on unique combinations of C1 and C2, as indicted in block 610.

In particular, in block 612, the ranking module 124 determines different applicable combinations of C1 and C2 coefficients to apply, and, in block 614 computes an individual score for each different C1 and C2 combination. In addition to the coefficients, the ranking module 124 uses web analytics data, such as the data reflected by the non-limiting sample data in Tables 1 and 2, to solve the different variations of the above equation. The operations in block 612 and 614 can effectively produce scores for the selected products (which were selected by and included in the result set by the relevancy algorithm of the search module 122).

As a further example, the following class II equations are provided for several different cases.

$$\begin{matrix}\{ ( \frac{1}{1 + {e}^{- RPV}} ) + ( 1.0 * Log ( Orders ) ) + ( 1.0 * Log ( \frac{Visits}{Product Views} ) ) \} & Equation 1 \\ \{ ( \frac{1}{1 + {e}^{- RPV}} ) + ( 1.96 * Log ( Orders ) ) + ( 1.0 * Log ( \frac{Visits}{Product Views} ) ) \} & Equation 2 \\ \{ ( \frac{1}{1 + {e}^{- RPV}} ) + ( 1.0 * Log ( Orders ) ) + ( 1.96 * Log ( \frac{Visits}{Product Views} ) ) \} & Equation 3\end{matrix}$$

In Equation 1, the orders value used may be the non-scaled value and the ratio of visits by product views may be the scaled value.

In a first case, Equation 1 may be solved for products that are within 67% (e.g., 1σ) of the scaled orders/cart adds, in which case, if the value of scaled orders divided by cart adds is less than or equal to 0.67, a score is computed using Equation 1 above, otherwise the score is nominal (e.g., 0). In other words, IF(Value of Scaled Orders/Cart Adds<=0.67, Result of Eq. 1,0).

In a second case, Equation 1 may be solved for products that are within 67% (e.g., 1σ) of the scaled ratio of visits/product views, in which case, if the value of scaled ratio of visits to product views is less than or equal to 0.67, a score is computed using Equation 1 above, otherwise the score is nominal (e.g.,. 0). In other words, IF(Value of Scaled Ratio of Visits/Prod Views<=0.67,Result of Eq. 1,0).

When the value is not zero (e.g., for when Orders >0), the ranking algorithm may select the result of the first case. Otherwise, the ranking algorithm may select the result of the second case. In other words, IF(Result of Case 1<=0,Result of Case 2,Result of Case 1).

TABLE 3
Sample Scores for Cases 1 and 2 using sample data from Tables 1 and 2.

| | | Class-II | Class-II | Class-II |
|---|---|---|---|---|
| Index | Product_ID | Equ-1a | Equ-1b | Equ-1 |
| 1 | 1305396 | 2.167739185 | 2.167739185 | 2.167739185 |
| 2 | 1493178 | 0 | 2.55520441 | 2.55520441 |
| 3 | 764796 | 2.661406992 | 2.661406992 | 2.661406992 |
| 4 | 1326714 | #NUM! | #NUM! | #NUM! |
| 5 | 1056414 | 2.651278014 | 2.651278014 | 2.651278014 |
| 6 | 989971 | 0 | 0 | 0 |
| 7 | 923528 | 1.661645681 | 1.661645681 | 1.661645681 |
| 8 | 857086 | 0 | #NUM! | #NUM! |
| 9 | 790643 | 0 | 2.999576091 | 2.999576091 |
| 10 | 724200 | 0 | 1.920818754 | 1.920818754 |
| 11 | 657757 | 0 | 2.741634417 | 2.741634417 |
| 12 | 591314 | 0 | 2.918602153 | 2.918602153 |
| 13 | 524872 | 0 | #NUM! | #NUM! |
| 14 | 458429 | 0 | 2.386201605 | 2.386201605 |
| 15 | 391986 | 0 | 2.335792102 | 2.335792102 |
| 16 | 325543 | #NUM! | #NUM! | #NUM! |
| 17 | 259100 | 0 | 1.447158031 | 1.447158031 |
| 18 | 192658 | 2.869996547 | 2.869996547 | 2.869996547 |
| 19 | 126215 | 0 | 2.692072085 | 2.692072085 |
| 20 | 59772 | 1.785704388 | 1.785704388 | 1.785704388 |

In Equation 2, the orders value used may be the non-scaled value and the ratio of visits by product views may be the scaled value.

In a third case, Equation 2 may be solved for products that are within 95% (e.g., 2σ) of the scaled orders/cart adds, in which case, if the value of scaled ratio of orders to cart additions is less than or equal to 0.95, a score is computed using Equation 2 above, otherwise the score is nominal (e.g., 0). In other words, IF(Value of Scaled Orders/Cart Adds<=0.95,Result of Eq. 2,0).

In a fourth case, Equation 2 may be solved for products that are within 67% (e.g., 1σ) of the scaled ratio of visits/prod views, in which case, if the value of scaled ratio of visits to product views is less than or equal to 0.67, a score is computed using Equation 2 above, otherwise the score is nominal (e.g., 0). In other words, IF(Value of Scaled Ratio of Visits/Prod Views<=0.67,Result of Eq. 2,0).

When the value is not nominal (e.g., zero), such as when Orders>0, the ranking algorithm may select the result of the third case. Otherwise, the ranking algorithm may select the result of the fourth case (e.g., using the ratio of visits to product views instead). In other words, IF(Result of Case 3<=0,Result of Case 4,Result of Case 3).

TABLE 4
Sample Scores for Cases 3 and 4 using
sample data from Tables 1 and 2.

| | | Class-II | Class-II | Class-II |
|---|---|---|---|---|
| Index | Product_ID | Equ-2a | Equ-2b | Equ-2 |
| 1 | 1305396 | 2.625775589 | 2.625775589 | 2.625775589 |
| 2 | 1493178 | 0 | 3.226215615 | 3.226215615 |
| 3 | 764796 | 3.697420989 | 3.697420989 | 3.697420989 |
| 4 | 1326714 | #NUM! | #NUM! | #NUM! |
| 5 | 1056414 | 3.229255606 | 3.229255606 | 3.229255606 |
| 6 | 989971 | 0 | 0 | 0 |
| 7 | 923528 | 1.950634477 | 1.950634477 | 1.950634477 |
| 8 | 857086 | 0 | #NUM! | #NUM! |
| 9 | 790643 | 4.155531275 | 4.155531275 | 4.155531275 |
| 10 | 724200 | 0 | 1.920818754 | 1.920818754 |
| 11 | 657757 | 3.657707226 | 3.657707226 | 3.657707226 |
| 12 | 591314 | 0 | 3.785568541 | 3.785568541 |
| 13 | 524872 | 0 | #NUM! | #NUM! |
| 14 | 458429 | 2.84423801 | 2.84423801 | 2.84423801 |
| 15 | 391986 | 0 | 3.295792102 | 3.295792102 |
| 16 | 325543 | #NUM! | #NUM! | #NUM! |
| 17 | 259100 | 0 | 1.736146827 | 1.736146827 |
| 18 | 192658 | 3.869733525 | 3.869733525 | 3.869733525 |
| 19 | 126215 | 3.503366203 | 3.503366203 | 3.503366203 |
| 20 | 59772 | 1.785704388 | 1.785704388 | 1.785704388 |

$$\{ ( \frac{1}{1 + {e}^{- RPV}} ) + ( 1.0 * Log ( Orders ) ) + ( 1.96 * Log ( \frac{Visits}{Product Views} ) ) \} \qquad Equation 3$$

In Equation 3, the orders value used may be the non-scaled value and the ratio of visits by product views may be the scaled value.

In a fifth case, Equation 3 is solved for products that are within 67% (1σ) of the scaled orders/cart adds, in which case, if the value of scaled ratio of orders to cart additions is less than or equal to 0.67, a score is computed using Equation 3 above, otherwise the score is nominal (e.g., 0). In other words, IF(Value of Scaled Orders/Cart Adds<=0.67,Result of Eq. 3,0).

In a sixth case, Equation 3 is solved for products that are within 95% (2σ) of the scaled ratio of visits/prod_views, in which case, if the value of scaled ratio of visits to product views is less than or equal to 0.95, a score is computed using Equation 3 above, otherwise the score is nominal (e.g., 0). In other words, IF(Value of Scaled Ratio of Visits/Prod Views<=0.95,Result of Eq. 3,0).

When the value is not zero (e.g., for when Orders>0), the ranking algorithm may select the result of the fifth case. Otherwise, the ranking algorithm may select the result of the sixth case (e.g., using Ratio of Visits to Product Views instead). In other words, IF(Result of Case 5≦=0, Result of Case 6, Result of Case 5).

TABLE 5
Sample Scores for Cases 5 and 6 using sample data from Tables 1 and 2.

| | | Class-II | Class-II | Class-II |
|---|---|---|---|---|
| Index | Product_ID | Equ-3a | Equ-3b | Equ-3 |
| 1 | 1305396 | 2.830732397 | 2.830732397 | 2.830732397 |
| 2 | 1493178 | 0 | 3.37718944 | 3.37718944 |
| 3 | 764796 | 3.220343709 | 3.220343709 | 3.220343709 |
| 4 | 1326714 | #NUM! | #NUM! | #NUM! |
| 5 | 1056414 | 3.658527316 | 3.658527316 | 3.658527316 |
| 6 | 989971 | 0 | 0 | 0 |
| 7 | 923528 | 2.00783674 | 2.00783674 | 2.00783674 |
| 8 | 857086 | 0 | #NUM! | #NUM! |
| 9 | 790643 | 0 | 3.763213955 | 3.763213955 |
| 10 | 724200 | 0 | 2.804804758 | 2.804804758 |
| 11 | 657757 | 0 | 3.497530647 | 3.497530647 |
| 12 | 591314 | 0 | 3.893493833 | 3.893493833 |
| 13 | 524872 | 0 | #NUM! | #NUM! |
| 14 | 458429 | 0 | 3.258918742 | 3.258918742 |
| 15 | 391986 | 0 | 2.65815252 | 2.65815252 |
| 16 | 325543 | #NUM! | #NUM! | #NUM! |
| 17 | 259100 | 0 | 1.587440946 | 1.587440946 |
| 18 | 192658 | 3.665456255 | 3.665456255 | 3.665456255 |
| 19 | 126215 | 0 | 3.505167168 | 3.505167168 |
| 20 | 59772 | 2.539980601 | 2.539980601 | 2.539980601 |

Class III relevancy scoring may use Equation 4 shown below to bring the products with high revenue and low bounce rate to a certain level of prominence even though they are low performers (low conversion from browsing to purchasing) with respect to orders, visits, cart additions and so forth.

$$\{ ( \frac{1}{1 + {e}^{- RPV}} ) + ( 2.48 * Log ( Orders ) ) + ( 2.48 * Log ( \frac{Visits}{Product Views} ) ) \} \qquad Equation 4$$

Returning to FIG. 6, in block 630, the method 600 determines whether RPV (which may be scaled in this implementation) for the product satisfied a certain threshold Tₕ. If so, the method 600 in block 632 computes a score using

$$\{ ( \frac{1}{1 + {e}^{- RPV}} ) + ( C 1 * Log ( Orders ) ) + ( C 2 * Log ( \frac{Visits}{Product Views} ) ) \} ,$$

with a specific value for C1 and C2, such as but not limited to 2.48.

As a further example, in a seventh case, Equation 4 may be solved for products where scaled RPV is greater than 95% (2σ) as shown in block 630. In this example, if the value of scaled RPV is greater than 0.95, a score is computed using Equation 4 above, otherwise this score is nominal (e.g., 0). In other words, IF(Value of Scaled RPV>0.95,Result of Eq. 4,0).

In this example, the orders value used may be the non-scaled value and the ratio of visits by product views may be the scaled value, although other variations are also possible in this equation as well as the use cases discussed herein. If RPV does not satisfy Tₕ, then a nominal score (e.g. zero) is assigned in block 650.

If in block 640, the method 600 determines whether RPV (which may be scaled in this implementation) for the product is equal to a nominal value (e.g., 0 in an eighth case), the method 600 may proceed to compute a score by solving the equation:

$$( \frac{1}{1 + {e}^{- RPV}} )$$

If the value of RPV (scaled) is not equal to the nominal value, then the method 600 may proceed to assign the product a nominal score (e.g., 0) in block 650. In block 640, the orders value used may be the non-scaled value and the ratio of visits by product views may be the scaled value, although other variations for this equation and the use cases are also possible in this equation. The operation in block 640 is advantageous as it can provide representation for newer, non-sold, products.

TABLE 6
Sample Scores for Cases 7 and 8.

| | | Class-III | Class-III | |
|---|---|---|---|---|
| Index | Product_ID | Equ-4a | Equ-4b | Class-II 4 |
| 1 | 1305396 | 0 | 0 | 0 |
| 2 | 1493178 | 0 | 0 | 0 |
| 3 | 764796 | 0 | 0 | 0 |
| 4 | 1326714 | 0 | 1 | 1 |
| 5 | 1056414 | 0 | 0 | 0 |
| 6 | 989971 | 0 | 0 | 0 |
| 7 | 923528 | 0 | 0 | 0 |
| 8 | 857086 | 0 | 0.999999999 | 0.999999999 |
| 9 | 790643 | 0 | 0 | 0 |
| 10 | 724200 | 3.28363051 | 0 | 3.28363051 |
| 11 | 657757 | 0 | 0 | 0 |
| 12 | 591314 | 0 | 0 | 0 |
| 13 | 524872 | 0 | 1 | 1 |
| 14 | 458429 | 0 | 0 | 0 |
| 15 | 391986 | 0 | 0 | 0 |
| 16 | 325543 | 0 | 1 | 1 |
| 17 | 259100 | 0 | 0 | 0 |
| 18 | 192658 | 0 | 0 | 0 |
| 19 | 126215 | 0 | 0 | 0 |
| 20 | 59772 | 0 | 0 | 0 |

Once the scores are computed, the ranking module 124 determines the rank. For instance, in the above example, the final score column is populated with the maximum score generated by Equation 1, 2, or 3 for the cases where Equation 4 result is zero. Otherwise, the calculated Equation 4 score is picked. The following Table 7 illustrates the ranked set of results with a commentary column included for context for each ranking.

| | | | RPV | | Cart | Prod | | | |
|---|---|---|---|---|---|---|---|---|---|
| Index | Product_ID | Ranking | (Customer) | Orders | Adds | Views | Visits | ASP | Comments |
| 9 | 790643 | 4.155531275 | 314 | 16 | 19 | 41 | 256 | 34.18 | High flow |
| | | | | | | | | | from Prod |
| | | | | | | | | | Views to Cart |
| | | | | | | | | | Adds to |
| | | | | | | | | | Orders |
| 12 | 591314 | 3.893493833 | 178 | 8 | 8 | 22 | 228 | 26.36 | High RPV to |
| | | | | | | | | | Prod Views |
| 18 | 192658 | 3.869733525 | 609 | 11 | 18 | 46 | 310 | 18.08 | High Prod |
| | | | | | | | | | Views to Cart |
| | | | | | | | | | Adds |
| 3 | 764796 | 3.697420989 | 456 | 12 | 23 | 56 | 214 | 84.07 | High Prod |
| | | | | | | | | | Views to Cart |
| | | | | | | | | | Adds |
| 5 | 1056414 | 3.658527316 | 214 | 4 | 6 | 10 | 112 | 56.56 | Good flow |
| | | | | | | | | | from Prod |
| | | | | | | | | | Views to Cart |
| | | | | | | | | | Adds to |
| | | | | | | | | | Orders |
| 11 | 657757 | 3.657707226 | 442 | 9 | 10 | 31 | 190 | 28.54 | Good flow |
| | | | | | | | | | from Prod |
| | | | | | | | | | Views to Cart |
| | | | | | | | | | Adds to |
| | | | | | | | | | Orders |
| 19 | 126215 | 3.505167168 | 101 | 7 | 9 | 33 | 232 | 17.19 | High Cart |
| | | | | | | | | | Adds to |
| | | | | | | | | | Orders |
| 2 | 1493178 | 3.37718944 | 119 | 5 | 5 | 11 | 79 | 111.09 | High Cart |
| | | | | | | | | | Adds to |
| | | | | | | | | | Orders |
| 15 | 391986 | 3.295792102 | 304 | 10 | 10 | 18 | 39 | 21.45 | High Cart |
| | | | | | | | | | Adds to |
| | | | | | | | | | Orders |
| 10 | 724200 | 3.28363051 | 644 | 1 | 1 | 3 | 25 | 31.11 | High RPV to |
| | | | | | | | | | Visits |
| 14 | 458429 | 3.258918742 | 501 | 3 | 4 | 9 | 73 | 22.87 | High Cart |
| | | | | | | | | | Adds to |
| | | | | | | | | | Orders |
| 1 | 1305396 | 2.830732397 | 302 | 3 | 7 | 21 | 103 | 163.72 | High Prod |
| | | | | | | | | | Views to |
| | | | | | | | | | Visits |
| 20 | 59772 | 2.539980601 | 502 | 1 | 2 | 19 | 116 | 16.37 | High Prod |
| | | | | | | | | | Views to |
| | | | | | | | | | Visits |
| 7 | 923528 | 2.00783674 | 521 | 2 | 5 | 17 | 39 | 42.61 | High Prod |
| | | | | | | | | | Views to |
| | | | | | | | | | Visits |
| 17 | 259100 | 1.736146827 | 103 | 2 | 2 | 5 | 7 | 19.08 | Low |
| | | | | | | | | | Acceptance |
| 4 | 1326714 | 1 | 0 | 0 | 4 | 21 | 178 | 67.62 | New |
| | | | | | | | | | Additions/ |
| | | | | | | | | | Unseen |
| 13 | 524872 | 1 | 0 | 0 | 0 | 10 | 113 | 24.49 | New |
| | | | | | | | | | Additions/ |
| | | | | | | | | | Unseen |
| 16 | 325543 | 1 | 0 | 0 | 2 | 12 | 43 | 20.2 | New |
| | | | | | | | | | Additions/ |
| | | | | | | | | | Unseen |
| 8 | 857086 | 0.999999999 | 0 | 0 | 0 | 0 | 21 | 37.93 | New |
| | | | | | | | | | Additions/ |
| | | | | | | | | | Unseen |
| 6 | 989971 | 0 | 481 | 1 | 1 | 1 | 43 | 48.6 | Low Selection |

It is noted that the above ranked list is reflect of an actual product ranking used in an enterprise e-commerce platform, such as that backing Staples.com.

Referring again to FIG. 1, the web server 134 includes computer logic executable by the processor 104 to process content requests. The web server 134 may include an HTTP server, a REST (representational state transfer) service, or other suitable server type. The web server 134 may receive content requests (e.g., product search requests, HTTP requests) from client devices 306, cooperate with the e-commerce application 136 and/or search engine 120 to determine the content, retrieve and incorporate data from the data store 108, format the content, and provide the content to the client devices.

In some instances, the web server 134 may format the content using a web language and provide the content to a corresponding client application 138 for processing and/or rendering to the user for display.

The web server 134 may be coupled to the data store 108 to store retrieve, and/or manipulate data stored therein and may be coupled to the e-commerce application 136 to facilitate its operations. For example, the web server 134 may allow a user on a client device 306 to communicate with the e-commerce application 136 and/or search engine 120.

The e-commerce application 136 includes computer logic executable by the processor 104 to provide an e-commerce service/marketplace for various products and may store and provide access to product information (e.g., images, descriptions, categories, specifications, reviews, ratings, retailers, etc.) in the product data 142 in a data store 108. The e-commerce application 136 may also place and provide for order fulfillment for the products including order delivery status and item returns. For example, a user may place orders for and/or pay for products, such as office supplies, consumer electronics, other products, etc., ordered on an e-commerce marketplace using a client device 306.

The e-commerce application 136 may also receive, manage, analyze, store, and provide access to inventory, sales, rewards, and product data. The e-commerce application 136 may communicate with the search engine 120 and the web server 134 to facilitate their operations and may be coupled to the data store 108 to store retrieve, and/or manipulate data stored therein. For example, the e-commerce application 136 may retrieve product data from a third-party server 318 and store it in the product data 142.

The client application 138 includes computer logic executable by the processor 104 on a client device 306 to provide for user interaction, receive user input, present information to the user via a display, and send data to and receive data from the other entities of the system 300 via the network 302. In some implementations, the client application 138 may generate and present user interfaces based at least in part on information received from the e-commerce application 136 and/or the web server 134 via the network 302. For example, a customer/user 314 may use the client application 138 to perform product searches, view search results, receive the product pages provided by the e-commerce server 322, view various products available online, add products to a virtual cart, purchase products, receive discounts on products, etc. In some implementations, the client application 138 includes a web browser and/or code operable therein, a customized client-side application (e.g., a dedicated mobile app), a combination of both, etc.

As depicted, the computing system 100 may include a processor 104, a memory 106, a communication unit 102, an output device 116, an input device 114, and a data store 108, which may be communicatively coupled by a communication bus 110. The computing system 100 depicted in FIG. 1 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 100 may include various operating systems, sensors, additional processors, and other physical configurations. Although, for purposes of clarity, FIG. 1 only shows a single processor 104, memory 106, communication unit 102, etc., it should be understood that the computing system 100 may include a plurality of one or more of these components.

The processor 104 may execute software instructions by performing various input, logical, and/or mathematical operations. The processor 104 may have various computing architectures to method data signals including, for example, a complex instruction set computer (CISC) architecture, a reduced instruction set computer (RISC) architecture, and/or an architecture implementing a combination of instruction sets. The processor 104 may be physical and/or virtual, and may include a single core or plurality of processing units and/or cores. In some implementations, the processor 104 may be capable of generating and providing electronic display signals to a display device, supporting the display of images, capturing and transmitting images, performing complex tasks including various types of feature extraction and sampling, etc. In some implementations, the processor 104 may be coupled to the memory 106 via the bus 110 to access data and instructions therefrom and store data therein. The bus 110 may couple the processor 104 to the other components of the computing system 100 including, for example, the memory 106, the communication unit 102, the input device 114, the output device 116, and the data store 108.

The memory 106 may store and provide access to data to the other components of the computing system 100. The memory 106 may be included in a single computing device or a plurality of computing devices. In some implementations, the memory 106 may store instructions and/or data that may be executed by the processor 104. For example, the memory 106 may store one or more of a search engine 120, a web server 134, an e-commerce application 136, a client application 138, and their respective components, depending on the configuration. The memory 106 is also capable of storing other instructions and data, including, for example, an operating system, hardware drivers, other software applications, databases, etc. The memory 106 may be coupled to the bus 110 for communication with the processor 104 and the other components of computing system 100.

The memory 106 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 104. In some implementations, the memory 106 may include one or more of volatile memory and non-volatile memory (e.g., RAM, ROM, hard disk, optical disk, etc.). It should be understood that the memory 106 may be a single device or may include multiple types of devices and configurations.

The bus 110 can include a communication bus for transferring data between components of a computing device or between computing devices, a network bus system including the network 302 or portions thereof, a processor mesh, a combination thereof, etc. In some implementations, search engine 120, web server 134, e-commerce application 136, client application 138, and various other components operating on the computing device 100 (operating systems, device drivers, etc.) may cooperate and communicate via a communication mechanism included in or implemented in association with the bus 110. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 102 may include one or more interface devices (IF) for wired and wireless connectivity among the components of the system 300. For instance, the communication unit 102 may include, but is not limited to, various types known connectivity and interface options. The communication unit 102 may be coupled to the other components of the computing system 100 via the bus 110. The communication unit 102 may be coupled to the network 302 as illustrated by the signal line 112, depending on the configuration. In some implementations, the communication unit 102 can link the processor 104 to the network 302, which may in turn be coupled to other processing systems. The communication unit 102 can provide other connections to the network 302 and to other entities of the system 300 using various standard communication protocols.

The input device 114 may include any device for inputting information into the computing system 100. In some implementations, the input device 114 may include one or more peripheral devices. For example, the input device 114 may include a keyboard, a pointing device, microphone, an image/video capture device (e.g., camera), a touch-screen display integrated with the output device 116, etc.

The output device 116 may be any device capable of outputting information from the computing system 100. The output device 116 may include one or more of a display (LCD, OLED, etc.), a printer, a 3D printer, a haptic device, audio reproduction device, touch-screen display, etc. In some implementations, the output device is a display which may display electronic images and data output by the computing system 100 for presentation to a user 106. In some implementations, the computing system 100 may include a graphics adapter (not shown) for rendering and outputting the images and data for presentation on output device 116. The graphics adapter (not shown) may be a separate processing device including a separate processor and memory (not shown) or may be integrated with the processor 104 and memory 106.

The data store 108 is an information source for storing and providing access to data. The data stored by the data store 108 may organized and queried using various criteria including any type of data stored by them, such as product and analytics data (e.g., dependent variables associated with each product, web analytics associated with each product and/or customer, product identifiers, product attributes, product details, product names, where products were purchased from, etc.), user data (e.g., customer accounts, customer identifiers, customer actions, etc.), etc. The data store 108 may include data tables, databases, or other organized collections of data.

The components 120, 134, 136, 138, and/or components thereof (e.g., 122, 124, 126, 130, and/or 132), may be communicatively coupled by the bus 110 and/or the processor 104 to one another and/or the other components 102, 106, 108, 114, and 116 of the computing system 100. In some implementations, the components 120, 134, 136, and/or 138 may include computer logic (e.g., software logic, hardware logic, etc.) executable by the processor 104 to provide their acts and/or functionality. In any of the foregoing implementations, these components 120, 134, 136, and/or 138 may be adapted for cooperation and communication with the processor 104 and the other components of the computing system 100.

The data store 108 may be included in the computing system 100 or in another computing system and/or storage system distinct from but coupled to or accessible by the computing system 100. The data store 108 can include one or more non-transitory computer-readable mediums for storing the data. In some implementations, the data store 108 may be incorporated with the memory 106 or may be distinct therefrom. In some implementations, the data store 108 may store data associated with a database management system (DBMS) operable on the computing system 100. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

It should be understood that the system 100 illustrated in FIG. 1 is representative of an example system and that a variety of different system environments and configurations are contemplated and are within the scope of the present disclosure. For instance, various acts and/or functionality may be moved from a server to a client, or vice versa, data may be consolidated into a single data store or further segmented into additional data stores, and some embodiments may include additional or fewer computing devices, services, and/or networks, and may implement various functionality client or server-side. Further, various entities of the system may be integrated into a single computing device or system or divided into additional computing devices or systems, etc.

The FIG. 3 is a block diagram of an example system 300 including client devices and an e-commerce server for ranking search results based on customer intent. The illustrated system 300 may include a client device 306a . . . 306n (also referred to herein individually and/or collectively as 306), a third-party server 318, and an e-commerce server 322, which are electronically communicatively coupled via a network 302 for interaction with one another, although other system configurations are possible including other devices, systems, and networks. For example, the system 300 could include any number of client devices 306, third-party servers 318, e-commerce servers 322, and other systems and devices. The client devices 306a . . . 306n, and their components, may be coupled to the network 302 via signal lines 312a . . . 312n. The e-commerce server 322 and its components may be coupled to the network 302 via signal line 320. The third-party server 318 and its components may be coupled to the network 302 via signal line 316. The user 314a . . . 314n may access one or more of the devices of the system 300. For example, as depicted, a user 314a may access and/or interact with the client device 306a as illustrated by line 312a, a user 314b may access and/or interact with the client device 306b as illustrated by line 312b, and a user 314n may access and/or interact with the client device 306n as illustrated by line 110n.

The network 302 may include any number of networks and/or network types. For example, the network 302 may include, but is not limited to, one or more local area networks (LANs), wide area networks (WANs) (e.g., the Internet), virtual private networks (VPNs), wireless wide area network (WWANs), Long Term-Evolution (LTE) networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MIMS, XMS, IMAP, SMTP, POP, WebDAV, or other known protocols.

The client device 306 includes one or more computing devices having data processing and communication capabilities. The client device 306 may couple to and communicate with other client devices 306 and the other entities of the system 300 via the network 302 using a wireless and/or wired connection. Examples of client devices 306 may include, but are not limited to, mobile phones, tablets, laptops, desktops, netbooks, server appliances, servers, virtual machines, TVs, etc. The system 300 may include any number of client devices 306, including client devices of the same or different type.

A plurality of client devices 306a . . . 306n are depicted in FIG. 3 to indicate that the e-commerce server 322 and its components may aggregate information about and provide optimized price discounts to a multiplicity of user 314a . . . 314n on a multiplicity of client devices 306a . . . 306n. In some implementations, a single user may use more than one client device 306, which the e-commerce server 322 may track and aggregate interaction data associated with the user, which the search engine 120 may use to performs its acts and/or functions as discussed elsewhere herein. Users may have different habits based on the device they are on, and the e-commerce server 322 can determine those habits and produce a more optimized experience to the user.

The e-commerce server 322 may include an instance of the search engine 120 (the instances of the search engine 120a . . . 120n may be referred to herein independently and/or collectively as 120). In some configurations, the search engine 120 may be distributed over the network 302 on disparate devices in disparate locations or may reside on the same locations, in which case the client device 306a and/or the e-commerce server 322 may each include an instance of the search engine 120. The client devices 306 may also store and/or operate other software such as a client application 138, an e-commerce application 136, operating system, other applications, etc., that are configured to interact with the e-commerce server 322 via the network 302.

The e-commerce server 322 and the third-party server 318 have data processing, storing, and communication capabilities, as discussed elsewhere herein. For example, the servers 322 and/or 318 may include one or more hardware servers, server arrays, storage devices and/or systems, etc. In some implementations, the servers 322 and/or 318 may include one or more virtual servers, which operate in a host server environment. As depicted, the e-commerce server 322 may include an e-commerce application 136, the search engine 120, and a web server 134, as discussed elsewhere herein.

Third-party server 318 can host services such as a third-party application (not shown), which may be individual and/or incorporated into the services provided by the e-commerce server 322. In some implementations, the third-party application provides additional acts and/or information such as browsing history, tracking information, profile data, shopping data, competitive pricing, competitive offers, web analytics, etc., to the e-commerce server 322 for storage in the data store 108, which is further described in reference to FIG. 1.

It should be understood that the system 300 illustrated in FIG. 3 is representative of an example system and that a variety of different system environments and configurations are contemplated and are within the scope of the present disclosure. For instance, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Further, various entities of the system may be integrated into a single computing device or system or divided into additional computing devices or systems, etc.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services. Thus, it should be understood that a variety of different system environments and configurations are contemplated and are within the scope of the present disclosure. For instance, various functionality may be moved from a server to a client, or vice versa and some implementations may include additional or fewer computing devices, services, and/or networks, and may implement various functionality client or server-side. Further, various entities of the described system(s) may be integrated into to a single computing device or system or additional computing devices or systems, etc. In addition, while the system 100 depicted in FIG. 1 provides an example of an applicable computing architecture, it should be understood that any suitable computing architecture, whether local, distributed, or both, may be utilized in the system 100.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to a computing device and/or other apparatus for performing the operations herein. This computing device may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in executable software, which includes but is not limited to an application, firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Communication unit(s) (e.g., network interfaces, etc.) may also be coupled to the system to enable the data processing system to become coupled to other data processing systems, storage devices, remote printers, etc., through intervening private and/or public networks, such as the network 202.

Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol / Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MIMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A method, executable by a computing system including one or more processors and one or more memories, for ranking and sorting search results generated by a search engine, the method comprising:
receiving, using the one or more processors, a search query including one or more search keywords;
responsive to receiving the search query, determining, using the one or more processors, from among product entries stored in a product database reflecting products purchasable via one or more online marketplaces, a set of matching product entries matching the one or more search keywords;
computing, using the one or more processors, a plurality of scores for each product entry using different combinations of coefficients and an amount of revenue-per-visit, a number of orders, and a ratio of page visits to product views associated with the product entry;
scaling, using the one or more processors, one or more of the amount of revenue-per-visit, the number of orders, and the ratio of page visits to product views associated with each product entry relative to a maximum amount of revenue-per-visit, a maximum number of orders, and maximum ratio of page visits to product views available in the set of product entries, respectively;
responsive to determining the set of matching product entries matching the one or more search keywords, ranking, using the one or more processors, the set of matching product entries based on a rank associated with each matching product entry in the set of matching product entries, the rank computed based on a comparison between the plurality of scores associated with the matching product entry; and
transmitting, using the one or more processors, the ranked set of matching product entries for presentation.

2. The method of claim 1, wherein computing the scores for each product entry further includes, for at least one score, comparing a ratio of orders and a number of cart additions to a predetermined threshold, and, if the ratio of the orders and the number of cart additions satisfies the predetermined threshold, calculating a score value for the at least one score based on the amount of revenue-per-visit, the number of orders, and the ratio of page visits to product views associated with the product entry.

3. The method of claim 2, wherein the predetermined threshold is one or more standard deviations of a scaled value of the ratio of the orders and the number of cart additions or a scaled value of the ratio of page visits to product views.

4. The method of claim 1, wherein computing the scores includes calculating a score value for two or more different cases using the equation:
$$\{ ( \frac{1}{1 + {e}^{- RPV}} ) + ( C 1 * Log ( Orders ) ) + ( C 2 * Log ( \frac{Visits}{Product Views} ) ) \} ,$$
the different cases being based on unique combinations of C2 and C2.

5. The method of claim 1, further comprising:
computing the rank of each product entry based on the comparison between the plurality of scores associated with the product entry.

6. A method, executable by a computing system including one or more processors and one or more memories, for ranking and sorting search results, comprising:
receiving, using the one or more processors, a search query including one or more search keywords;
responsive to receiving the search query, determining, using the one or more processors, from among product entries stored in a product database reflecting products purchasable via one or more online marketplaces, a set of matching product entries matching one or more keywords;
computing, using the one or more processors, a rank associated with each matching product entry in the set of matching product entries using a different combination of coefficients and an amount of revenue-per-visit, a number of orders, and a ratio of page visits to product views associated with the matching product entry; and
ranking, using the one or more processors, the set of matching product entries based on a rank associated with each matching product entry in the set of matching product entries.

7. The method of claim 6, wherein computing the rank further includes:
computing, using the one or more processors, a plurality of scores for each matching product entry in the set of matching product entries using different combinations of coefficients and the amount of revenue-per-visit, the number of orders, and the ratio of page visits to product views associated with the matching product entry, wherein the rank for each matching product entry is computed based on a comparison between the plurality of scores associated with the matching product entry.

8. The method of claim 7, wherein at least one of the plurality of scores for at least one product is computed comparing a ratio of orders and a number of cart additions to a predetermined threshold, and, if the ratio of the orders and the number of cart additions satisfies the predetermined threshold, calculating a score value for the at least one score based on the amount of revenue-per-visit, the number of orders, and the ratio of page visits to product views associated with the product entry.

9. The method of claim 8, wherein the predetermined threshold is one or more standard deviations of a scaled value of the ratio of orders and the number of cart additions or a scaled value of the ratio of page visits to product views.

10. The method of claim 7, wherein computing the plurality of scores includes calculating a score value for each of two or more different cases using the equation:
$$\{ ( \frac{1}{1 + {e}^{- RPV}} ) + ( C 1 * Log ( Orders ) ) + ( C 2 * Log ( \frac{Visits}{Product Views} ) ) \} ,$$
the different cases being based on unique combinations of C1 and C2.

11. The method of claim 6, further comprising:
computing, using the one or more processors, the rank associated with each matching product entry in the set of matching product entries based on the comparison between a plurality of scores associated with the product entry.

12. The method of claim 6, wherein one or more of the amount of revenue-per-visit, the number of orders, and the ratio of page visits to product views associated with each product entry are scaled relative to a maximum amount of revenue-per-visit, maximum number of orders, and a maximum ratio of page visits to product views available in the set of product entries.

13. A system comprising:
one or more processors;
one or more memories storing instructions that, when executed by the one or more processors, cause the system to perform operations including:
receiving a search query including one or more search keywords;
responsive to receiving the search query, determining from among product entries stored in a product database reflecting products purchasable via one or more online marketplaces, a set of matching product entries matching one or more keywords;
computing a rank associated with each matching product entry in the set of matching product entries using a different combination of coefficients and an amount of revenue-per-visit, a number of orders, and a ratio of page visits to product views associated with the matching product entry; and
ranking the set of matching product entries based on a rank associated with each matching product entry in the set of matching product entries.

14. The system of claim 13, wherein computing the rank further includes:
computing a plurality of scores for each matching product entry in the set of matching product entries using different combinations of coefficients and the amount of revenue-per-visit, the number of orders, and the ratio of page visits to product views associated with the matching product entry, wherein the rank for each matching product entry is computed based on a comparison between the plurality of scores associated with the matching product entry.

15. The system of claim 14, wherein at least one of the plurality of scores for at least one product is computed comparing a ratio of orders and a number of cart additions to a predetermined threshold, and, if the ratio of the orders and the number of cart additions satisfies the predetermined threshold, calculating a score value for the at least one score based on the amount of revenue-per-visit, the number of orders, and the ratio of page visits to product views associated with the product entry.

16. The system of claim 15, wherein the predetermined threshold is one or more standard deviations of a scaled value of the ratio of orders and the number of cart additions or a scaled value of the ratio of page visits to product views.

17. The system of claim 14, wherein computing the plurality of scores includes calculating a score value for each of two or more different cases using the equation:
$$\{ ( \frac{1}{1 + {e}^{- RPV}} ) + ( C 1 * Log ( Orders ) ) + ( C 2 * Log ( \frac{Visits}{Product Views} ) ) \} ,$$
the different cases being based on unique combinations of C1 and C2.

18. The system of claim 13, further comprising:
computing the rank associated with each matching product entry in the set of matching product entries based on the comparison between a plurality of scores associated with the product entry.

19. The system of claim 13, wherein one or more of the amount of revenue-per-visit, the number of orders, and the ratio of page visits to product views associated with each product entry are scaled relative to a maximum amount of revenue-per-visit, maximum number of orders, and a maximum ratio of page visits to product views available in the set of product entries.
